(19) United States
(12) Patent Application Publication
(10) Pub. No.: US 2019/0067968 A1
(43) Pub. Date: Feb. 28, 2019

(54) Interchangeable Powering Assembly for Smart Ring

(71) Applicant: Titanium Falcon, Inc., Delaware Company, San Jose, CA (US)

(72) Inventor: Huijuan Guo, San Jose (CN)

(21) Appl. No.: 15/688,781

(22) Filed: Aug. 28, 2017

(51) Int. Cl. H02J 7/00; H01R 24/76; H01R 13/502; G06F 1/16; A44C 9/00

(52) U.S. Cl. CPC H02J 7/0045; H01R 24/76; H01R 2103/00; G06F 1/163; A44C 9/0053; H01R 13/502

(57) ABSTRACT

An interchangeable powering assembly for a smart ring that is worn on a segment of a finger of a user. The assembly powers the smart ring without requiring the smart ring to be removed from the finger, but rather through at least one interchangeable power source having ornamental characteristics. The power source detachably couples to the smart ring through an integrated retention housing and a coupling member. The retention housing integrates into the smart ring. The retention housing includes at least one internal contact for electrically communicating with the electrical and sensing components of the smart ring, and at least one external contact for electrically communicating with the interchangeable power source. The coupling member detachably mounts into a housing aperture that forms in the retention housing to carry electrical power from the interchangeable power source to the retention housing for electrical distribution to the smart ring through the contacts.

### FIELD OF THE INVENTION

The present invention relates generally to an interchangeable powering assembly for a smart ring. More so, the present invention relates to a powering assembly for providing power to a smart ring through use of at least one interchangeable power source having ornamental characteristics that detachably couples to the smart ring through a coupling member and a retention housing; whereby the assembly comprises a retention housing having at least one internal electrical contact for electrically communicating with a smart ring, and at least one external electrical contact for electrically communicating with the interchangeable power source; and whereby the coupling member detachably mounts into a housing aperture to carry electrical power from the interchangeable power source to the retention housing for electrical distribution to the smart ring through the electrical contacts; and whereby the smart ring does not require removal from a user's finger to charge, but rather charging is possible by interchanging multiple power sources with the ring, so as to achieve a new ornamental look and to provide a fresh charge.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a smart ring is a wearable electronics device with advanced mobile components that combine a circuitry, at least one sensor, an accelerometers, and a small battery to enable operation of communication devices through a close-range wireless technology, such as Bluetooth™. Often, a smart ring is fabricated from an allergy free, surgical quality stainless steel, and may have a circumference between about 15.7 millimeters and 23.83 millimeters, so as to fit around the human finger.

In one typical use of the smart ring, a set of pressure sensors are positioned on an inner surface of the smart ring and configured to sense changes to tendons of the user's finger as pressure differentials and to output associated signals. Often, a gesture component interprets the signals from the set of pressure sensors to identify individual actions performed by the user's finger. The smart ring may also be adapted as a hands-free notification system that pairs with a smartphone to remotely control multiple devices with the pointer finger.

In any case, the smart ring requires an integrated or external power source to power the chips, sensors, and other circuitry. This power source often depletes due to the great amount of data communications used with the smart ring. Also, the smart ring must be removed from the finger for recharging. Furthermore, the smart ring is often a simple stainless steel band that does not provide ornamental effects. This can limit use of the smart ring for social events and the like.

Other proposals have involved powering and enhancing the appearance of a smart ring. The problem with these devices is that they do not provide sufficient power source, and they require the user to remove the smart ring from the finger for recharging. Even though the above cited smart ring devices meet some of the needs of the market, a powering assembly for providing power to a smart ring through use of at least one interchangeable power source having ornamental characteristics that detachably couples to the smart ring through a coupling member and a retention housing, is still desired.

### SUMMARY

Illustrative embodiments of the disclosure are generally directed to an interchangeable powering assembly for a smart ring that is worn on a first segment of a finger of a user. The interchangeable powering assembly, hereafter “assembly” is operational to provide power to the smart ring without requiring the smart ring to be removed from the finger, through use of at least one interchangeable power source having ornamental characteristics, and that detachably couples to the smart ring through an integrated retention housing and a coupling member. The ornamental characteristics of the power supply allows the user to express individual tastes directly on the smart ring.

In some embodiments, the assembly comprises a retention housing that is integrated into a smart ring. The retention housing includes at least one internal contact for electrically communicating with the electrical and sensing components of the smart ring, and at least one external contact for electrically communicating with the interchangeable power source. The coupling member detachably mounts into a housing aperture that forms in the retention housing to carry electrical power from the interchangeable power source to the retention housing for electrical distribution to the smart ring through the contacts. In this manner, the smart ring does not require removal from the finger of the user to charge, but rather charging the smart ring is possible by interchanging the at least one power source. The interchangeable power source may have an ornamental characteristic in addition to the function charging characteristic described above.

In one aspect, an interchangeable powering assembly for a smart ring, comprises:
a retention housing integrated into a smart ring, the retention housing defined by sidewalls, the retention housing forming a housing aperture, the retention housing comprising at least one internal electrical contact extending from the housing aperture, the retention housing further comprising at least one external electrical contact extending from the sidewalls, the at least one external electrical contact being electrically connectable to the smart ring;
at least one interchangeable power source providing power to the smart ring, the at least one interchangeable power source defined by an ornamental shape; and
a coupling member defined by a power end and a ring end, the power end operationally connected to the interchangeable power source, the ring end sized and dimensioned to electrically connect to the retention housing through detachable coupling with the housing aperture,
whereby the smart ring receives power by interchanging multiple interchangeable power sources.

In one aspect, the smart ring is configured to be worn on a first segment of a finger of a user.

In another aspect, the smart ring comprises a circuitry, a sensor, and a close-range wireless processor chip.

In another aspect, the smart ring is fabricated from an allergy free, surgical quality stainless steel.

In another aspect, the smart ring has a circumference between about 15.7 millimeters and 23.83 millimeters.

In another aspect, the retention housing has a generally square shape.

In another aspect, the housing aperture has a rectangular shape with two depressions.

In another aspect, the at least one internal electrical contact comprises two longitudinal metal tabs disposed on opposite ends of the housing aperture.

In another aspect, the at least one external electrical contact comprises two circular metal tabs and two rectangular metal tabs.

In another aspect, the at least one interchangeable power source is a rechargeable battery having at least 22 maH of power.

In another aspect, the at least one interchangeable power source includes at least one of the following shapes: a cube, a gem, a rhombus, a disc, a sphere, a star, a pyramid, a panel, and an ornamental shape.

In another aspect, the coupling member is an elongated metal rod.

One objective of the present invention is to charge a smart ring without requiring removal of the smart ring from a segment of the finger.

Another objective is to provide a coupling member that easily attaches the power source to the retention housing.

Yet another objective is to provide multiple interchangeable power sources with each power source having a unique ornamental shape.

Yet another objective is to provide an inexpensive to manufacture power source for a smart ring.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary interchangeable powering assembly detached from a smart ring, in accordance with an embodiment of the present invention;

FIG. 2 illustrates a perspective view of the interchangeable powering assembly shown in FIG. 1, where the retention housing is coupled to the interchangeable power supply, in accordance with an embodiment of the present invention;

FIG. 3 illustrates a perspective view of an exemplary retention housing, in accordance with an embodiment of the present invention;

FIG. 4 illustrates a frontal view of the retention housing shown in FIG. 3, in accordance with an embodiment of the present invention;

FIG. 5 illustrates a top view of the retention housing, in accordance with an embodiment of the present invention;

FIG. 6 illustrates a bottom view of the retention housing, in accordance with an embodiment of the present invention;

FIG. 7 illustrates a perspective view of the retention housing and an exemplary interchangeable power supply, in accordance with an embodiment of the present invention;

FIG. 8 illustrates a top view of the retention housing and the interchangeable power supply shown in FIG. 7, in accordance with an embodiment of the present invention;

FIG. 9 illustrates a bottom view of the retention housing and the interchangeable power supply, in accordance with an embodiment of the present invention; and

FIG. 10 illustrates a rear view of the retention housing and the interchangeable power supply, in accordance with an embodiment of the present invention.

Like reference numerals refer to like parts throughout the various views of the drawings.

### DETAILED DESCRIPTION OF THE INVENTION

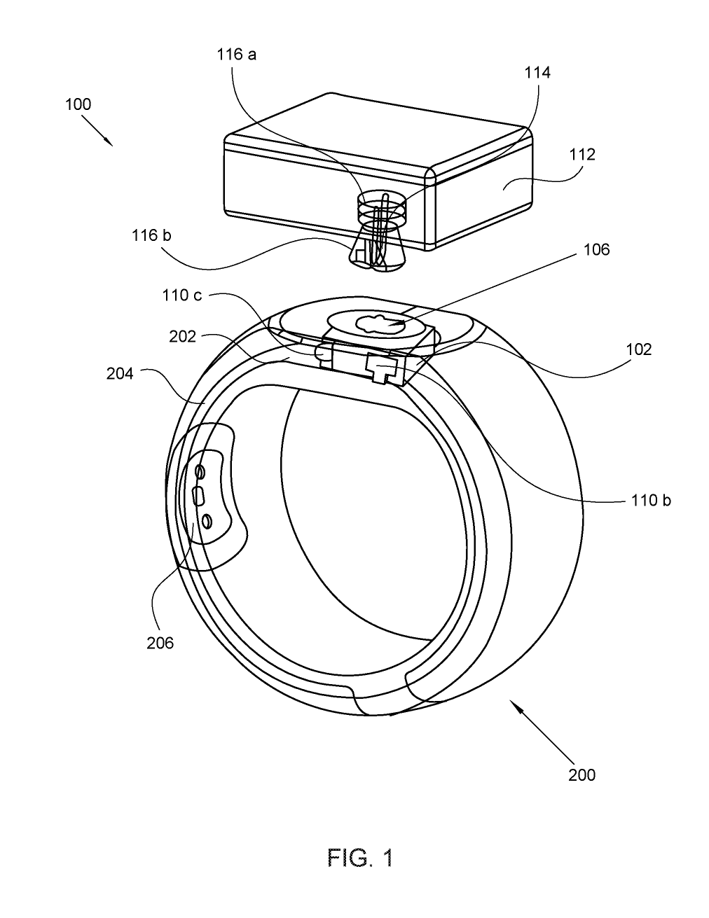

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An interchangeable powering assembly 100 for a smart ring is referenced in FIGS. 1-10. The interchangeable powering assembly 100, hereafter “assembly 100” is configured to integrate into a smart ring 200 for powering a circuitry 202, sensor 204, and close-range wireless processor chip 206 that controls communication of the smart ring 200. The assembly 100 allows the smart ring 200 to be powered for these purposes without requiring removal of the smart ring 200 from the finger, but rather through direct coupling of at least one interchangeable power source 112 with the smart ring 200 via a retention housing 102 and a coupling member 114. In this manner, the smart ring 200 does not require removal from the finger of the user to charge, but rather, the charging function is performed by interchanging multiple power sources with the smart ring 200. Further, the interchangeable power source 112 is defined by an ornamental characteristic in addition to the charging functionality described above, so as to achieve a new ornamental look and to provide a fresh charge.

As referenced in FIG. 1, the assembly 100 powers a smart ring 200 that is worn on a first segment of a finger of a user. The smart ring 200 may be integral with the assembly 100, or the assembly 100 may be configured to interchangeably adapt to different smart rings in a universal arrangement. In either case, the smart ring 200 is electrically charged without requiring removal thereof from the finger; and further, the smart ring 200 is powered through use of an ornamentally characterized interchangeable power supply 112.

In some embodiments, the smart ring 200 is a generally ring-shaped, wearable electronics device that fits on the segments of the finger. The smart ring 200 may be adapted with advanced mobile components that combine a circuitry 202, at least one sensor 204, an accelerometer, a processor chip 206 that enables operation of communication devices through a close-range wireless technology, such as Bluetooth™. These components require electrical power to operate. In one embodiment, the smart ring 200 is fabricated from an allergy free, surgical quality stainless steel. In another embodiment, the smart ring 200 has a circumference between about 15.7 millimeters and 23.83 millimeters.

In one exemplary use, the smart ring 200 may also include a set of pressure sensors positioned on an inner surface of the ring and configured to sense changes to tendons of the user's finger as pressure differentials and to output associated signals. The example can further include a gesture component configured to interpret the signals from the set of pressure sensors to identify individual actions performed by the user's finger. In yet other embodiments, the smart ring 200 may also be adapted as a hands-free notification system that pairs with a smartphone to remotely control multiple devices with the pointer finger.

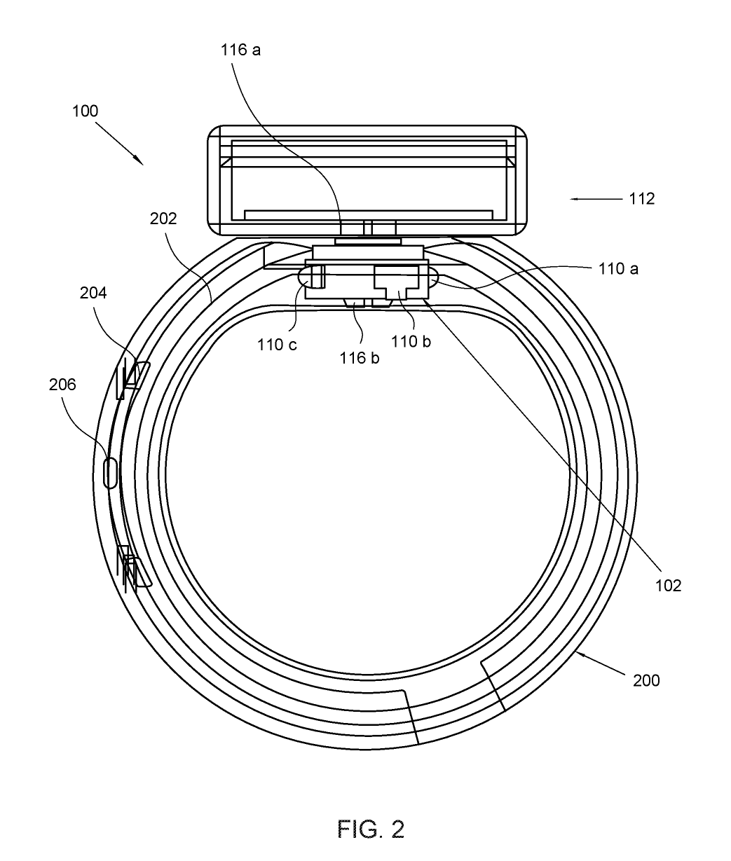

Looking now to FIG. 2, the assembly 100 integrates into the surface or ring-shaped body of the smart ring 200. The assembly 100 is unique in that electrical power is provided to the smart ring 200 without requiring the smart ring 200 to be removed from the finger of the user. This is accomplished through use of at least one interchangeable power source 112, such as a battery. The interchangeable power source 112 is configured to detachably couple to the smart ring 200 through an integrated retention housing 102 and an elongated coupling member 114. The interchangeable power source 112 may have ornamental characteristics to provide greater uniqueness to the smart ring 200. The ornamental characteristics of the power source 112 allows the user to express multiple individual tastes directly on the smart ring 200.

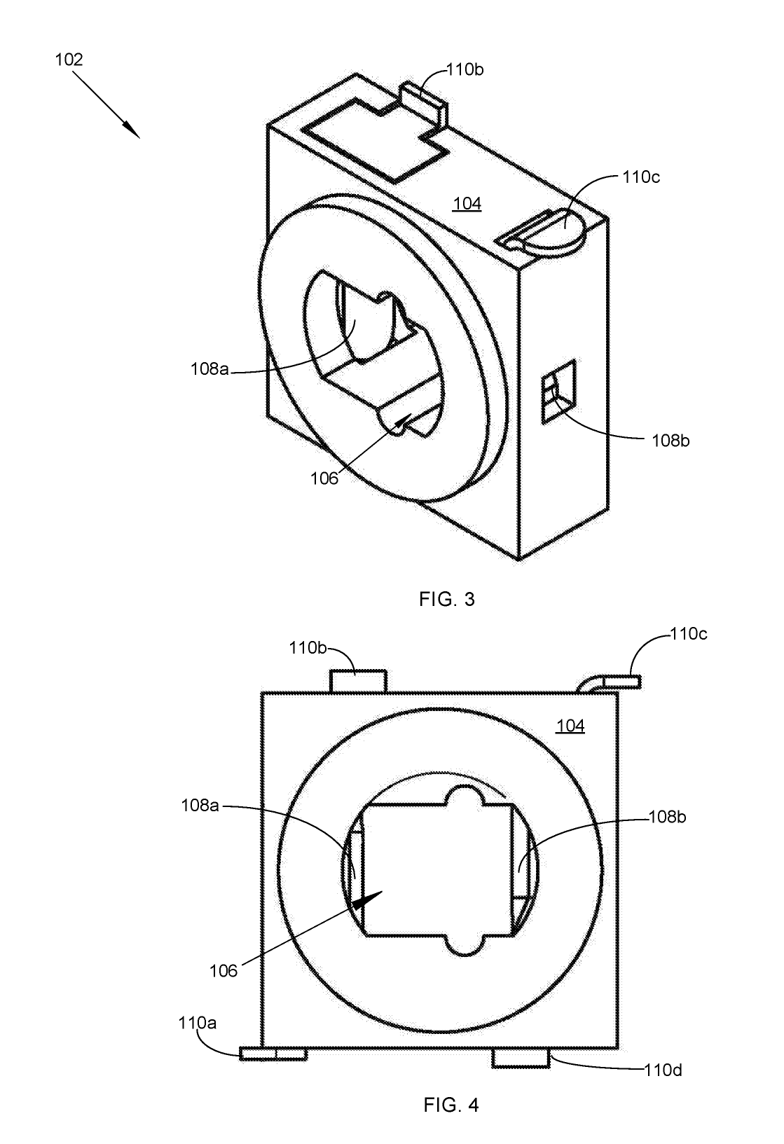

As shown in FIG. 3, the assembly 100 comprises a retention housing 102 that is integrated into the smart ring 200. The retention housing 102 may have a generally square or rectangular shape that fits snugly in a cavity that forms in the smart ring 200. However in other embodiments, the retention housing 102 may take other shapes.

The retention housing 102 is defined by sidewalls 104 that may form a rectangular or square shape. The sidewalls 104 of the retention housing 102 form a housing aperture 106 having a generally rectangular or circular shape. The housing aperture 106 enables passage of the coupling member 114 for detachable coupling with the power source 112. In one possible configuration of the housing aperture 106, two oppositely disposed depressions may form along the contours of the housing aperture 106, as shown in FIG. 4. As discussed below, the housing aperture 106 is configured to receive a coupling member 114 for detachable coupling of an interchangeable power source 112 with the smart ring 200.

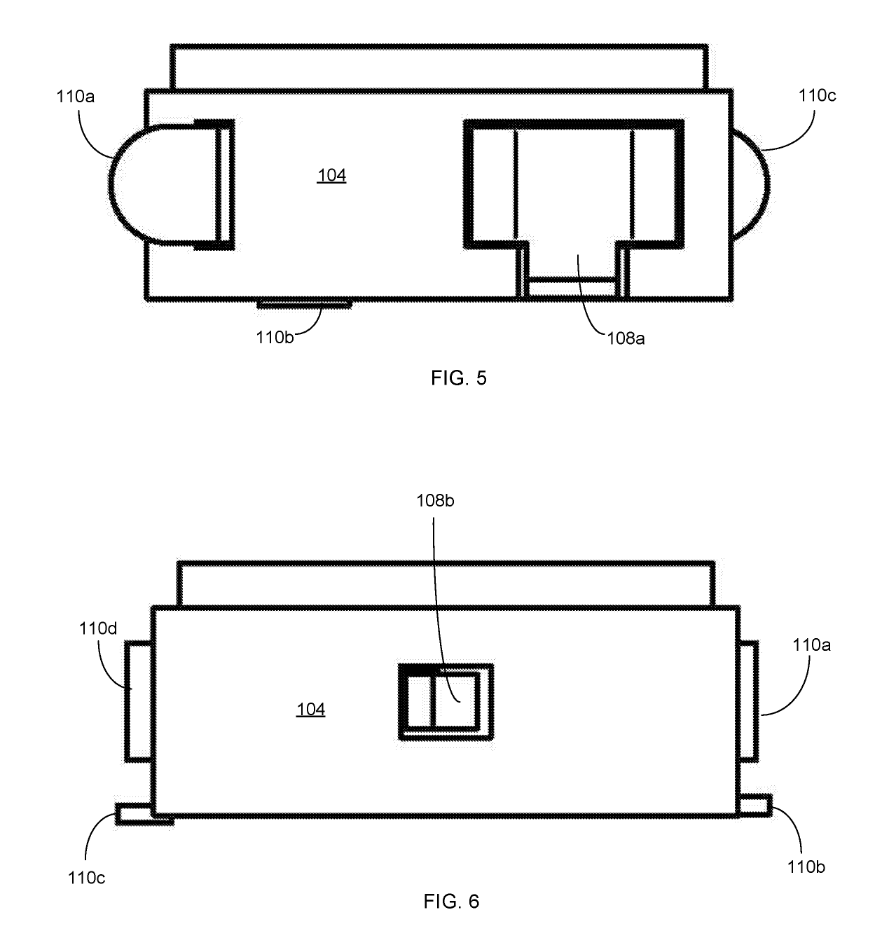

Turning now to FIG. 5, the retention housing 102 includes at least one internal electrical contact 108a-b that serves to enable electrical communication with the electrical, processing, and sensing components of the smart ring 200 discussed above. The internal electrical contact 108a-b extends through the housing aperture 106, and may be tensioned to extend in a natural position, and retract when a force, such as the coupling member 114 passes through the housing aperture 106. In one possible embodiment, the internal electrical contact 108a-b may include two longitudinal metal tabs 108a, 108b disposed on opposite ends of the housing aperture 106. The metal used may include brass or other metal known in the art for transmitting electricity.

As illustrated in FIG. 6, the retention housing 102 includes also includes at least one external electrical contact 110a-d that extends from the sidewalls 104. The external electrical contact 110a-d is configured to electrically communicate with the interchangeable power source 112; and thereby receive electrical power therefrom. The external and internal electrical contacts 108a-b, 110a-d are in electrical communication. The at least one external electrical contact 110a-d may include, without limitation, two circular metal tabs 110a, 110c and two rectangular metal tabs 110b, 10d.

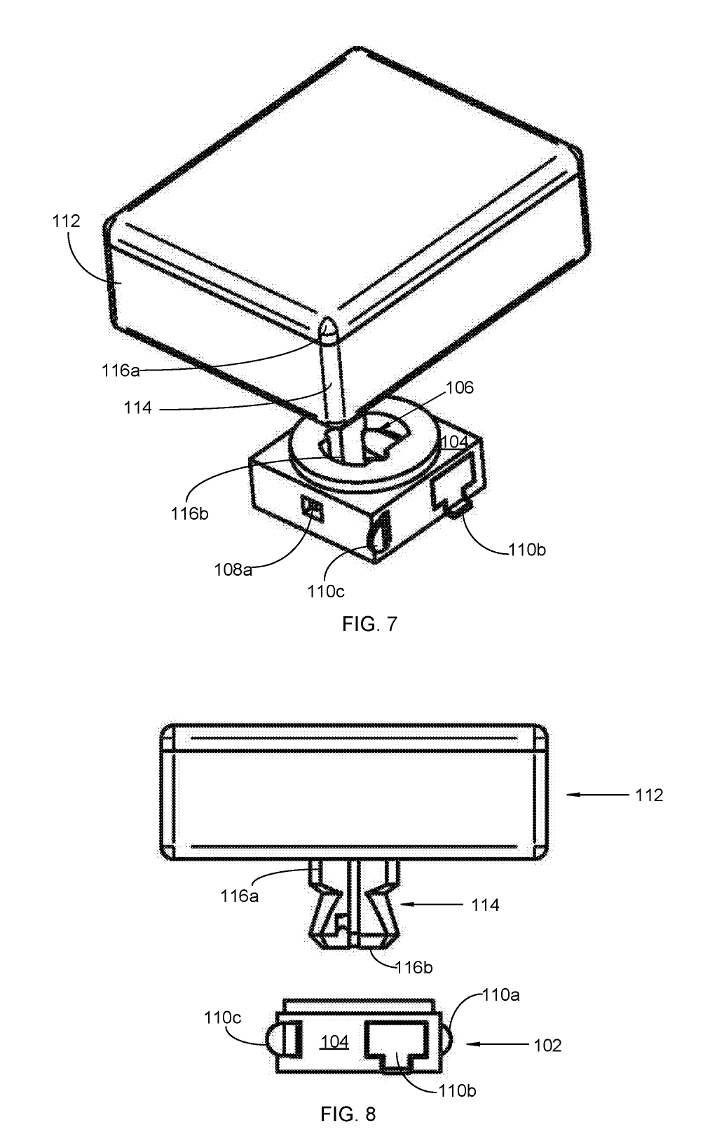

Looking now at FIG. 7, the assembly 100 comprises at least one interchangeable power source 112. The interchangeable power source 112 is configured to provide electrical power to the smart ring 200. This externally sourced electrical power is required to recharge depleted internal power in the smart ring 200. In one embodiment, the interchangeable power source 112 is a rechargeable battery having at least 22 maH of power. Though any small battery used in small electrical devices may also be used.

Further, the interchangeable power source 112 defined by an ornamental shape to provide greater uniqueness to the smart ring 200. The ornamental characteristics of the power source 112 allows the user to express individual tastes directly on the smart ring 200. Possible ornamental shapes that could be used for the power source 112 may include, without limitation, a cube, a gem, a rhombus, a disc, a sphere, a star, a pyramid, a panel, and an ornamental shape. For example, the user may attach a cube-shaped power supply to the smart ring 200 for charging, and then replace it with a gem-shaped power supply for donning at a social event. In both cases, the smart ring receives a charge. Also, the power source 112 can be changed to provide a fresh source of electrical power in addition to the fashion statement described here.

Turning to FIG. 8, the assembly 100 provides a coupling member 114 that detachably mounts into the housing aperture 106 to connect the smart ring 200 to the power source 112. The coupling member 114 is configured to carry electrical power from the interchangeable power source 112 to the retention housing 102 for electrical distribution to the smart ring 200 through the internal electrical contacts 108a-b.

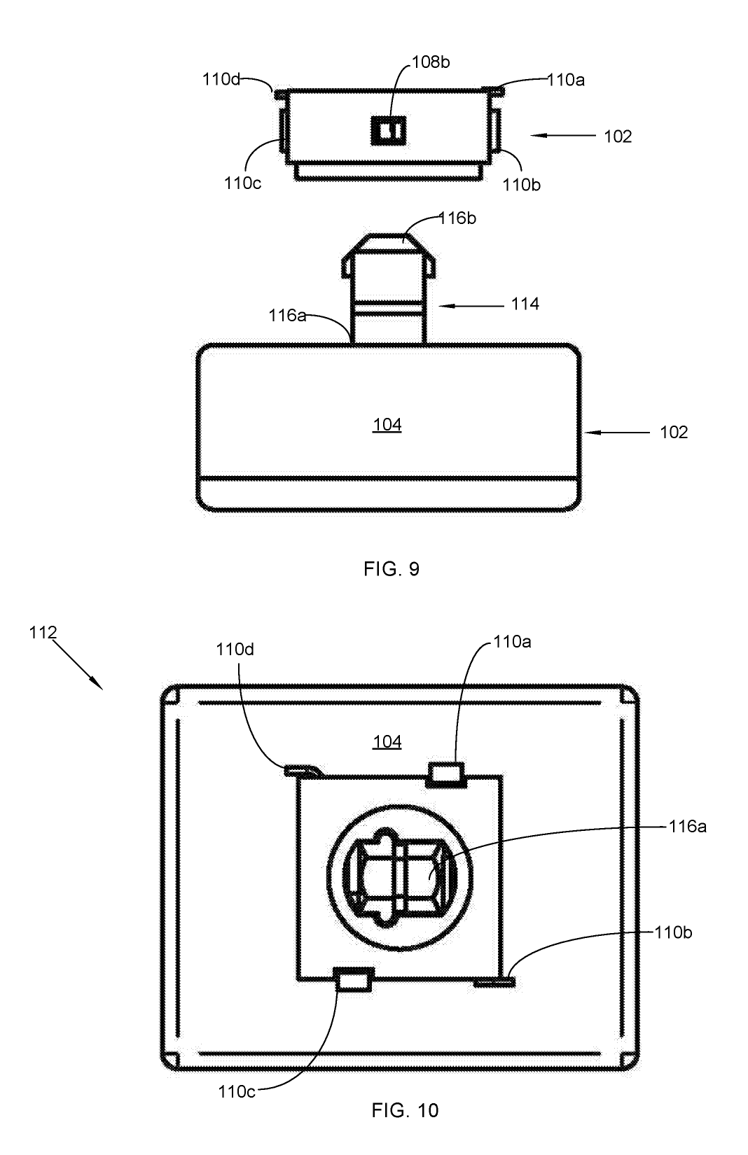

In one embodiment, the coupling member 114 is defined by a power end 116a and a ring end 116b. The power end 116a is operationally connected to the interchangeable power source 112. As shown in FIG. 9, the ring end 116b is sized and dimensioned to electrically connect to the retention housing 102 through detachable coupling with the housing aperture 106. In one embodiment, the ring end 116b is tapered and has multiple ridges that fit snugly with depressions that form the contour of the housing aperture 106.

In yet another embodiment, shown in FIG. 10, the coupling member 114 comprises an elongated metal rod with ridges that are sized and dimensioned to form a snug fit in the housing aperture 106. The coupling member 114 allows the smart ring 200 to receive power by interchanging multiple interchangeable power sources, as the coupling member 114 forms a snug, yet axially displaceable arrangement with the housing aperture 106. In this manner, the power source 112 easily attaches and detaches to the smart ring 200, and the smart ring does not require removal from a user's finger to charge, but rather charging is possible by interchanging multiple power sources.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An interchangeable powering assembly for a smart ring, the assembly comprising:
a retention housing integrated into a smart ring, the retention housing defined by sidewalls, the retention housing forming a housing aperture, the retention housing comprising at least one internal electrical contact extending from the housing aperture, the retention housing further comprising at least one external electrical contact extending from the sidewalls, the at least one external electrical contact being electrically connectable to the smart ring;
at least one interchangeable power source providing power to the smart ring, the at least one interchangeable power source defined by an ornamental shape; and
a coupling member defined by a power end and a ring end, the power end operationally connected to the interchangeable power source, the ring end sized and dimensioned to electrically connect to the retention housing through detachable coupling with the housing aperture,
whereby the smart ring receives power from multiple interchangeable power sources.

2. The assembly of claim 1, wherein the smart ring is configured to be worn on a first segment of a finger of a user.

3. The assembly of claim 1, wherein the smart ring comprises a circuitry, a sensor, and a close-range wireless processor chip.

4. The assembly of claim 1, wherein the smart ring is fabricated from an allergy free, surgical quality stainless steel.

5. The assembly of claim 1, wherein the smart ring has a circumference between about 15.7 millimeters and 23.83 millimeters.

6. The assembly of claim 1, wherein the retention housing has a generally square shape.

7. The assembly of claim 1, wherein the housing aperture has a rectangular shape with two depressions.

8. The assembly of claim 1, wherein the at least one internal electrical contact comprises two longitudinal metal tabs disposed on opposite ends of the housing aperture.

9. The assembly of claim 1, wherein the at least one external electrical contact comprises two circular metal tabs and two rectangular metal tabs.

10. The assembly of claim 1, wherein the at least one interchangeable power source is a rechargeable battery having at least 22 maH of power.

11. The assembly of claim 1, wherein the at least one interchangeable power source includes at least one of the following shapes: a cube, a gem, a rhombus, a disc, a sphere, a star, a pyramid, a panel, and an ornamental shape.

12. The assembly of claim 1, wherein the coupling member comprises an elongated metal rod.

13. The assembly of claim 1, wherein the ring end of the coupling member is tapered and has ridges.

14. An interchangeable powering assembly, the assembly comprising:
a retention housing defined by sidewalls, the retention housing forming a housing aperture, the retention housing comprising at least one internal electrical contact extending from the housing aperture, the retention housing further comprising at least one external electrical contact extending from the sidewalls;
at least one interchangeable power source defined by an ornamental shape; and
a coupling member defined by a power end and a ring end, the power end operationally connected to the interchangeable power source, the ring end sized and dimensioned to electrically connect to the retention housing through detachable coupling with the housing aperture.

15. The assembly of claim 14, further comprising a smart ring.

16. The assembly of claim 15, wherein the retention housing is integrated into the smart ring.

17. The assembly of claim 16, wherein the at least one external electrical contact is electrically connectable to the smart ring.

18. The assembly of claim 17, wherein the at least one interchangeable power source includes at least one of the following shapes: a cube, a gem, a rhombus, a disc, a sphere, a star, a pyramid, a panel, and an ornamental shape.

19. The assembly of claim 14, wherein the coupling member comprises an elongated metal rod with a ridges and tapered ring end.

20. An interchangeable powering assembly for a smart ring, the assembly consisting of:
a rectangular retention housing integrated into a smart ring, the retention housing defined by sidewalls, the retention housing forming a housing aperture, the retention housing comprising two metal internal electrical contacts extending from the housing aperture, the retention housing further comprising four metal external electrical contacts extending from the sidewalls, the external electrical contacts being electrically connectable to the smart ring;
at least one interchangeable power source comprising a rechargeable battery, the at least one interchangeable power source providing power to the smart ring, the at least one interchangeable power source defined by an ornamental shape including at least one of the following: a cube, a gem, a rhombus, a disc, a sphere, a star, a pyramid, a panel, and an ornamental shape; and
a coupling member comprising an elongated metal rod with ridges, the coupling member defined by a power end and a ring end, the power end operationally connected to the interchangeable power source, the ring end sized and dimensioned to electrically connect to the retention housing through detachable coupling with the housing aperture,
whereby the smart ring receives power from multiple interchangeable power sources.
